(19) United States
(12) Patent Application Publication
(10) Pub. No.: US 2009/0122980 A1
(43) Pub. Date: May 14, 2009

(54) Cryptographic Method for Securely Implementing an Exponentiation, and an Associated Component

(75) Inventors: Mathieu Ciet, La Ciotat (FR); Karine Villegas, Gemenos (FR)

Correspondence Address: BUCHANAN, INGERSOLL & ROONEY PC, POST OFFICE BOX 1404, ALEXANDRIA, VA, 22313-1404, US

(73) Assignee: GEMPLUS, Gemenos (FR)

(21) Appl. No.: 11/988,750

(22) PCT Filed: Jul. 13, 2006
(86) PCT No.: PCT/EP2006/064228

§ 371 Date: Mar. 18, 2008

(30) Foreign Application Priority Data
Jul. 13, 2005 (FR) 0507519

(51) Int. Cl. H04L 9/30; H04L 9/28

(52) U.S. Cl. 380/30; 380/28

(57) ABSTRACT

An asymmetrical cryptographic method applied to a message M includes a private operation of signing or decrypting the message M to obtain a signed or decrypted message s. The private operation is based on at least one modular exponentiation EM in the form EM=M^{A} mod B, A and B being respectively the exponent and the modular exponentiation EM. The private operation includes the following steps: calculating an intermediate module B*, an intermediate message M* and an intermediate exponent A*, based on B, M and/or A; the intermediate module B* being deterministically calculated and the intermediate message M* being randomly calculated; calculating an intermediate modular exponentiation EM*=MA mod B*; and calculating the signed or decrypted message s based on the intermediate modular exponentiation EM*. An electronic component for implementing the cryptographic method is also disclosed.

### FIELD OF THE INVENTION

The present invention relates to a cryptographic method enabling an exponentiation to be implemented securely in an electronic component, such implementation being used more particularly in the context of an asymmetric cryptography algorithm, e.g. of the Rivest-Shamir-Adleman (RSA) type.

The invention also relates to an electronic component including means for implementing the method.

### STATE OF THE ART

Electronic components implementing cryptography algorithms are, in general, used in applications in which access to services or to data is severely controlled. They are of architecture such that they can execute any type of algorithm.

Such components can, in particular, be used in smart cards, for certain applications thereof.

Thus, such electronic components implement cryptography algorithms making it possible to encrypt transmitted data and/or to decrypt received data, to sign a message digitally, and/or to verify that digital signature.

On the basis of a message applied by a host system as input to the electronic component, and on the basis of secret numbers contained in the electronic component, the electronic component delivers the message as signed in return to the host system, thereby, for example, enabling the host system to authenticate the electronic component.

In analogous manner, on the basis of an encrypted message applied by a host system as input to the electronic component, and, on the basis of secret numbers contained in the electronic component, the electronic component decrypts the message.

The characteristics of the cryptography algorithms, such as the computations performed or the parameters used, can be known. The security of such cryptography algorithms lies essentially in the secret number(s) used in the algorithm. That number or those numbers are contained in the electronic component and are totally unknown to the outside environment.

They cannot be deduced merely from knowledge of the message applied as input and of the encrypted message delivered in return. Cryptographic algorithms of the RSA type are based on a mathematical problem that is deemed to be complex from a computational point of view for numbers that are sufficiently large, namely factorization.

In order to find the secret number(s), attacks consisting in physically tampering with the electronic component or with the smart card have been developed and thus, a certain number of appropriate protection techniques have emerged in order to counter such physical tampering.

However, it has appeared that the secret number(s) contained in the card can be uncovered by non-invasive attacks. Such attacks, known as “side-channel attacks”, make it possible for an external person or “eavesdropper” to determine the secret number(s) contained in the electronic component on the basis of physical magnitudes that are measurable from outside the component while said component is executing the cryptography algorithm.

The principle of such side-channel attacks is based on the fact that certain parameters characterizing the microprocessor vary depending on the instruction executed and on the data manipulated. Analyzing current consumption (power consumption), computation time, or indeed electromagnetic radiation makes it possible, for example, to discover the secret number(s).

Such side-channel attacks are also possible with cryptographic algorithms of the RSA type (that type being named after the initials of its inventors Rivest, Shamir, and Adleman) which is one of the most widely used in cryptography, in particular in the field of smart cards.

Various protection techniques for preventing such external attacks are known. For example, it is possible to use a power supply device comprising capacitors suitable for masking the fluctuations in current consumption. The computation devices can also be enclosed in shielded protective housings confining the electromagnetic radiation.

Unfortunately, such techniques are not totally infallible and an experienced eavesdropper can determine the secret number(s), e.g. by using amplified signal techniques, or indeed by filtering out the noise by averaging the data collected over several measurements.

Furthermore, in devices such as smart cards, such countermeasures are often inapplicable or insufficient in view of the various physical constraints on such devices, such as, in particular, dependency on external power sources, impossibility of using shielding, etc.

Other mathematical methods are known for preventing attacks based on measuring the computation times for the various operations. Unfortunately, they do not make it possible to protect against more complex attacks such as those based on analyzing current consumption.

Another method of protecting against side-channel attacks is presented in Patent Application WO 99/35782. That document presents a protection method that is usable in a cryptography algorithm of the RSA type, either in standard mode or in Chinese Remainder Theorem (CRT) mode, that protection method being mainly based on generating random numbers making it possible to redefine the computation parameters. Thus, the computations of the private operation of the RSA-type cryptography algorithm are made entirely random. Unfortunately, that countermeasure method suffers from the drawback of significantly increasing the computation times.

An object of the present invention is thus to provide a cryptographic method of the RSA type and an associated electronic component that make it possible to counter attacks of the side-channel type (be they simple or differential attacks) more rapidly and more effectively.

### SUMMARY OF THE INVENTION

To this end, the invention provides an asymmetric cryptographic method applied to a message M, said method being characterized in that it comprises a private operation consisting in signing or decrypting the message M for the purpose of obtaining a signed or decrypted message s, the private operation being defined on the basis of at least one modular exponentiation EM of the form EM=M^{A} mod B, where A and B are respectively the exponent and the modulus of the modular exponentiation EM, “mod” denoting the operation “modulo”, and the private operation comprising the steps consisting in:
computing an intermediate modulus B*, an intermediate message M*, and an intermediate exponent A*, as a function of B, M, and/or A; the intermediate modulus B* being computed deterministically and the intermediate message M* being computed randomly;
computing an intermediate modular exponentiation EM*=M*^{A}*mod B*; and
computing the signed or decrypted message s on the basis of the intermediate modular exponentiation EM*.

In a preferred but non-limiting aspect of the asymmetric cryptographic method of the invention, the step consisting in computing the signed or decrypted message s is performed by reducing EM*, which is the result of the intermediate modular exponentiation.

In a first implementation of the invention, a cryptographic method is provided that is characterized in that it uses a public key and a private key, the public key being composed of a modulus N of the RSA type and of a public exponent e, and the private key being composed of the modulus N of the RSA type and of a private exponent d, such that e·d=1 mod φ(N), where φ is Euler's totient function, and in that the private operation is defined on the basis of the modular exponentiation s=M^{d} mod N, where d and N correspond respectively to the exponent A and to the modulus B of the modular exponentiation EM, and comprises the steps consisting in:

a) computing an intermediate modulus N* in deterministic manner, such that N*=x_{N}·N, where x_{N} is a public value that depends on N and on M;

b) computing an intermediate message M* in random manner, such that M*=M+x_{M}·N, where x_{M} is a random value such that x_{N} and x_{M} are coprime;

c) computing an intermediate modular exponentiation s*=M*^{d}*mod N*, where d* corresponds to the intermediate exponent A*; and

d) reducing the intermediate modular exponentiation s* in order to obtain the signed or decrypted message s.

Preferred but non-limiting aspects of this first implementation of the invention are as follows:
the step a) consisting in computing an intermediate modulus N* in deterministic manner comprises the steps consisting in:

a1) computing a value λ such that λ=ƒ(M,N), where ƒ is a function that is deterministic and public;

a2) computing the public value x_{N} such that x_{N}=λ²·T, where T is a coefficient of normalization of the modular multiplication; and

a3) computing the intermediate modulus N* such that N*=x_{N}·N;
the step b) consisting in computing an intermediate message M* in random manner comprises the steps consisting in:

b1) drawing a random number r₁;

b2) computing x_{M}=1+λ·r₁·T; and

b3) computing the intermediate message M*=M+x_{M}·N;
the step a1) consisting in computing the value λ comprises the steps consisting in:

a11) decomposing M and N such that

$$M = {\sum }_{i} {M}_{i} {2}^{w , i} and N = {\sum }_{i} {N}_{i} {2}^{w , i}$$

where w is a non-zero integer; and

a12) constructing the value λ such that

$$λ = {\sum }_{i} {σ}_{{z}_{i}} ( {M}_{i} ) + {σ}_{{z}_{i}} ( {N}_{i} )$$

where σₐ is a function belonging to the group of the set of the permutations S of length a, and where zⱼ=Mⱼ+j+zⱼ₋₁+Nⱼ mod 2^{w}, it being possible for z₀ to be set at any value; and
the intermediate exponent d* is such that d*=d+r₂·(1−e·d), where r₂ is a number drawn randomly; the intermediate exponent d* may also be such that d*=d.

In a second implementation of the invention, a cryptographic method is provided that is characterized in that it uses a public key and a private key, the public key being composed of a public exponent e and of a modulus N of the RSA type that is the product of two large prime numbers p and q, and the private key being composed of the “quintuplet” (p,q,dₚ,d_{q},i_{q}), where dₚ=d mod(p−1), d_{q}=d mod(q−1), and i_{q}=q⁻¹ mod p, where d is such that e·d=1 mod φ(N), where φ is Euler's totient function, and in that the private operation is defined on the basis of the modular exponentiation sₚ=M^{dp} mod p, where dₚ, and p correspond respectively to the exponent A and to the modulus B of the modular exponentiation EM, and comprises the steps consisting in:

a1) computing an intermediate modulus p* in deterministic manner, such that p*=xₚ·p, where xₚ is a public value that depends on N and on M;

a2) computing an intermediate message Mₚ* in random manner, such that Mₚ*=[(M mod p*)+x_{Mp}·p] mod p*, where x_{Mp} is a random value such that xₚ and x_{Mp} are coprime; and

a3) computing an intermediate modular exponentiation sₚ* such that sₚ*=Mₚ*^{dp*}mod p*, where dₚ* corresponds to the intermediate exponent A*.

Preferred but non-limiting aspects of this second implementation of the invention are as follows:
step a2) is replaced with step a2′) consisting in computing an intermediate message Mₚ* such that Mₚ*=[M+x_{Mp}·p] mod p*, where x_{Mp} is a random value such that xₚ and x_{Mp} are coprime;
step a1) consisting in computing an intermediate modulus p* in deterministic manner comprises the steps consisting in:

a11) computing a value λₚ such that λₚ=ƒₚ(M,N mod 2^{k}), where ƒₚ is a function that is deterministic and public, and k is a positive non-zero integer;

a12) computing the public value xₚ such that xₚ=λₚ·T, where T is a coefficient of normalization of the modular multiplication; and

a13) computing the intermediate modulus p*;
step a2) consisting in computing an intermediate message Mp* in random manner comprises the steps consisting in:

a21) drawing a random number r₁;

a22) computing the random value x_{Mp} such that x_{Mp}=1+λₚ·r₁·T; and

a23) computing the intermediate message Mₚ*;
the intermediate exponent dₚ* is such that dₚ*=dₚ+λ_{dp}·(p−1), where λ_{dp} is such that λ_{dp}=ƒ_{dp}(M,N mod 2^{k}), where ƒ_{dp} is a function that is deterministic and public, and k is a positive non-zero integer; the intermediate exponent dₚ* may also be such that dₚ*=dₚ;
the private operation is further defined on the basis of the modular exponentiation s_{q}=M^{dq} mod q, and comprises the steps consisting in:

b1) computing an intermediate modulus q* in deterministic manner, such that q*=x_{q}·q, where x_{q} is a public value that depends on N and on M;

b2) computing an intermediate message M_{q}* in random manner, such that M_{q}*=[(M mod q*)+x_{Mq}·q] mod p*, where x_{Mq} is a random value such that x_{q} and x_{Mq} are coprime; and

b3) computing an intermediate modular exponentiation s_{q}* such that s_{q}*=M_{q}*^{dq*}mod q*, where d_{q}* is an intermediate exponent;
the step b2) is replaced with step b2′) consisting in computing an intermediate message M_{q}* such that M_{q}*=[M+x_{Mq}·q] mod q*, where x_{Mq} is a random value such that x_{q} and x_{Mq} are coprime;
the step b1) consisting in computing an intermediate modulus q* in deterministic manner comprises the steps consisting in:

b11) computing a value λ_{q} such that λ_{q}=ƒ_{q}(M,N mod 2^{k}), where ƒ_{q} is a function that is deterministic and public, and k is a positive non-zero integer;

b12) computing the public value x_{q} such that x_{q}=λ_{q}·T, where T is a coefficient of normalization of the modular multiplication; and

b13) computing the intermediate modulus q*;
the step b2) consisting in computing an intermediate message Mq* in random manner comprises the steps consisting in:

b21) drawing a random number r₂;

b22) computing the random value x_{Mq} such that x_{Mq}=1+λ_{q}·r₂·T; and

b23) computing the intermediate message M_{q}*;
the intermediate exponent d_{q}* is such that d_{q}*=d_{q}+λ_{dq}(q−1), where λ_{dq} is such that λ_{dq}=ƒ_{dq}(M,N mod 2^{k}), where ƒ_{dq} is a function that is deterministic and public, and k is a positive non-zero integer; the intermediate exponent d_{q}* may also be such that d_{q}*=d_{q};
the number k is less than 128;
the private operation further comprises the step consisting in computing the modular exponentiation s=M^{d} mod N on the basis of sₚ* and s_{q}*;
the step consisting in computing the modular exponentiation s=M^{d} mod N on the basis of sₚ* and s_{q}* comprises the steps consisting in:
recombining sₚ* and s_{q}* such that:

s*=s_{q}*+q·((i_{q}·(sₚ*−s_{q}*))mod p*); and
reducing s* to s;
the step consisting in reducing s* to s is performed using the modular reduction s=s*mod N;
the step consisting in computing the modular exponentiation s=M^{d} mod N on the basis of sₚ* and s_{q}* comprises the steps consisting in:
recombining sₚ* and s_{q}* such that:

s*=[x_{q}·s_{q}*+q*·((i_{q}·(sₚ*−s_{q}*))mod p*)]; and
computing:

$$s = \frac{s * mod ( {x}_{q} \cdot N )}{{x}_{q}} ;$$

and
the step consisting in computing the modular exponentiation s=M^{d} mod N on the basis of sₚ* and s_{q}* comprises the steps consisting in:
reducing the modular exponentiation sₚ* in order to determine the modular exponentiation sₚ;
reducing the modular exponentiation s_{q}* in order to determine the modular exponentiation s_{q}; and
recombining sₚ and s_{q} such that:

s=s_{q}+q·((i_{q}·(sₚ−s_{q}))mod p).

In another implementation of the invention an asymmetric cryptographic method is provided that is applied to a message M to be signed or decrypted into a signed or decrypted message s, said cryptographic method being characterized in that it uses a public key and a private key, the public key being composed of a public exponent e and of a modulus N of the RSA type that is the product of two large prime numbers p and q, and the private key being composed of the “quintuplet” (p,q,dₚ,d_{q},i_{q}), where dp=d mod(p−1), d_{q}=d mod(q−1), and i_{q}=q⁻¹ mod p, where d is such that e·d=1 mod φ(N), where φ is Euler's totient function, and comprises a private operation defined on the basis of the modular exponentiations sₚ and s_{q} such that sₚ=M^{dp} mod p, and s_{q}=M^{dq} mod q, the private operation comprising the steps consisting in:
computing an intermediate modulus p* on the basis of p, and an intermediate modus q* on the basis of q;
computing the intermediate modular exponentiations sₚ* and s_{q}*, sₚ* and s_{q}* being computed respectively on the basis of the moduli p* and q*; and
computing the signed or decrypted message s by combining sₚ* and s_{q}*.

Preferred but non-limiting aspects of this other implementation of the invention are as follows:
the signed or decrypted message s is computed using the steps consisting in:
recombining sₚ* and s_{q}* such that:

s*=s_{q}*+q·((i_{q}·(sₚ*−s_{q}*))mod p*); and
reducing s* to s;
the step consisting in reducing s* to s is performed using the modular reduction s=s*mod N; and
the intermediate modulus q* is computed such that q*=K·q, where K is a deterministic or random value, and the signed or decrypted message s is computed using the steps consisting in:
recombining sₚ* and s_{q}* such that:

s*=[K·s_{q}*+q* ·((i_{q}·(sₚ*−s_{q}*))mod p*)]
computing:

$$s = \frac{s * mod ( K \cdot N )}{K}$$

The invention also provides an electronic component including means for implementing the cryptographic method in the various implementations of the invention. For example, the electronic component includes programmed processor means, such as a microprocessor, for implementing the cryptographic method of the invention.

Finally, a smart card is provided that includes such an electronic component.

### DESCRIPTION OF THE FIGURES

Other characteristics and advantages of the invention appear from the following description which is given merely by way of non-limiting illustration, and should be read with reference to the accompanying drawings, in which:

FIG. 1 is a flow chart of a cryptographic method of the RSA type in standard mode in a preferred aspect of the invention;

FIG. 2 is a flow chart of a cryptographic method of the RSA type in CRT mode in another preferred aspect of the invention; and

FIG. 3 is a flow chart of the cryptographic method of the RSA type in CRT mode in yet another aspect of the invention.

### DESCRIPTION OF A PREFERRED IMPLEMENTATION OF THE INVENTION

### Operation of Cryptography Algorithms of the RSA Type

The main characteristics of the RSA-type cryptography system are recalled briefly below.

The first implementation of an encryption and public-key signature scheme was developed by Rivest, Shamir, and Adleman, who invented the RSA-type cryptographic system. That system is the public-key cryptographic system that is used most widely.

It can be used either as an encryption method or as a signature method.

The RSA-type cryptographic system uses modular exponentiation computations. It consists firstly in generating the pair of RSA keys that are then used for the modular exponentiations.

Thus, each user creates an RSA public key and a corresponding private key using the following 5-step method:

1) Generate two distinct prime numbers p and q;

2) Compute N=p·q and φ(N)=(p−1)·(q−1), (where φ is Euler's totient function);

3) Select an integer e such that 1<e<φ(N) and such that e and φ(N) are coprime, e being chosen randomly or otherwise;

4) Compute an integer d such that 1<d<(N) and such that e·d=1 mod φ(N) [it should be noted that throughout the text, the operation “modulo k” is designated by “mod k”]; and

5) The public key is the pair (N,e) and the private key is the pair (N,d).

The integers e and d are respectively referred to as the “public exponent” and as the “private exponent”. The integer N is referred to as the RSA modulus.

Thus, once the public and private parameters have been defined, then, given x, where 0<x<N, it is possible to apply the encryption or signature method to x.

In the encryption method, the public operation on x, which operation is referred to as “encryption of the message x”, consists in computing the modular exponentiation:

y=x^{e} mod N

In which case, the corresponding private operation is the operation of decrypting the encrypted message y, and it consists in computing the modular exponentiation:

y^{d} mod N

In the signature method, the first operation performed is the private operation, or “signature of the message x”, and it consists in computing:

y=x^{d} mod N

The corresponding public operation or “verification of the signature y”, uses the public key (N,e) and the values x and y, and it consists in determining whether the equation x=y^{e} mod N is verified.

The mode presented above is referred to as the “standard mode”.

Another mode of operation for the RSA cryptography algorithm, namely the “Chinese Remainder Theorem” or “CRT” mode is presented below. The CRT mode of operation is much faster than the standard mode. In the CRT mode, instead of the modular exponentiation being directly computed modulo N, firstly two modular exponentiation computations are performed, respectively modulo p and modulo q.

The public parameters are still represented by the pair (N,e) but the private parameters are, in this mode, represented by the triplet (p,q,d) or by the “quintuplet” (p,q,dₚ,d_{q},i_{q}) where:

dₚ=d mod(p−1)

d_{q}=d mod(q−1)

i_{q}=q⁻¹ mod p

By means of the relationship e·d=1 mod φ(N), it is possible to obtain:

e·dₚ=1 mod(p−1); and

e·d_{q}=1 mod(q−1).

The public operation takes place in the same way as for the standard mode of operation. Conversely, for the private operation, firstly, the following modular exponentiations are computed:

yₚ=x^{dp} mod p; and

y_{q}=x^{dq} mod q.

Then, by applying the Chinese remainder theorem, it is possible to obtain y=x^{d} mod N, by using, for example, Garner's formula:

y=y_{q}+q·((i_{q}·(yₚ−y_{q}))mod p)

As already recalled above, the characteristics of cryptography algorithms are generally known, and the security of such algorithms is thus essentially based on the secret numbers that are used.

It thus appears from the above that, in a cryptography algorithm of the RSA type, the operation that must be protected is the “private” operation. The private operation is the only operation of the cryptography algorithm that uses private numbers that are not known to the outside environment, namely the private exponent d in an RSA cryptography algorithm in standard mode, and the numbers p, q, dₚ, d_{q}, and i_{q} forming the private elements in an RSA cryptography algorithm in CRT mode.

Attacks of the side-channel type, be they simple or differential, are based on analysis of the computations performed during the cryptography algorithm.

The countermeasure proposed in this document is thus a method for securely implementing an exponentiation that prevents detection from the outside of the private number(s) used in the cryptography algorithm of the RSA type, in particular during the private operation.

In any RSA-type cryptography algorithm, be it in standard mode or in CRT mode, the private operation applied to the message M is always defined on the basis of at least one modular exponentiation EM of the type EM=M^{A} mod B. In this modular exponentiation, M, A, and B are respectively referred to as “the base”, “the exponent”, and “the modulus”.

In standard mode, the private operation is defined on the basis of a single modular exponentiation:

s=M^{d} mod N

In CRT mode, the private operation is defined on the basis of two modular exponentiations, namely:

sₚ=M^{dp} mod p; and

s_{q}=M^{dq} mod q.

In accordance with the invention, the private operation is based on the use of intermediate parameters, coming from the computation parameters A, B, or M, and can thus take place through the steps consisting in:
computing an intermediate modulus B*, an intermediate message M*, and an intermediate exponent A*, the intermediate modulus B* and the intermediate message M* being respectively computed deterministically and randomly;
computing an intermediate modular exponentiation EM*=M*^{A}*mod B*; and
computing the signed or decrypted message s on the basis of the intermediate modular exponentiation EM*.

The intermediate exponent A* is computed randomly or deterministically. The intermediate exponent A* can, for example, be such that A*=A.

The computations of the intermediate parameters B*, M*, and A* can be performed in a different order, the only constraint being that they must be computed before the modular exponentiation EM* is computed.

### RSA-Type Cryptographic Method in Standard Mode

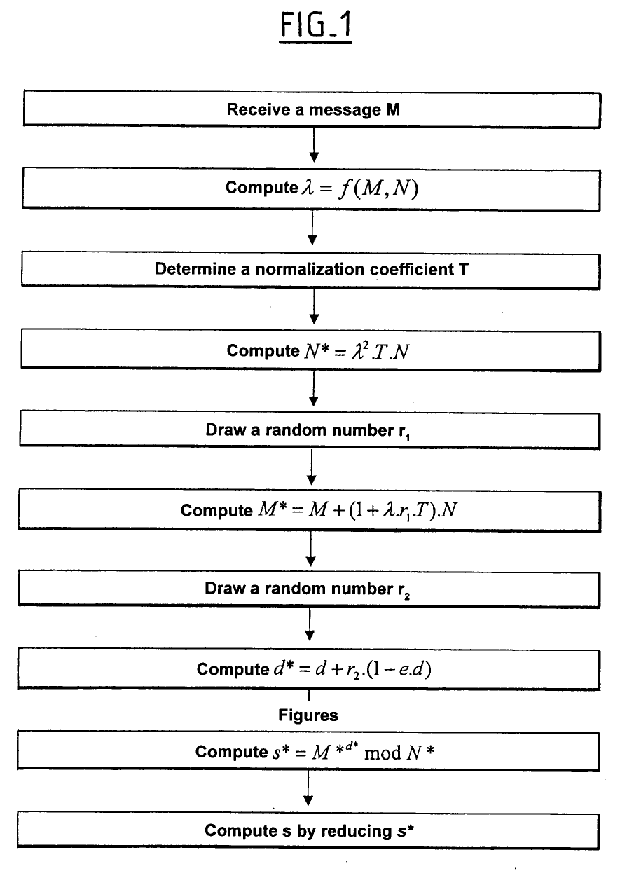

The method of securely implementing the RSA-type cryptography algorithm in standard mode is described below with reference to FIG. 1.

The implementation of the invention that is presented below relates to the RSA-type cryptography algorithm in standard mode for a signature operation.

However, the invention is not limited to such a signature method and can also be used in a message encryption method.

Let us consider a message M to be signed, a modulus N of the RSA type, a public exponent e and a private exponent d.

The method described below makes it possible to perform a private operation that is totally secure, i.e. to perform secure generation of a signature s such that s=M^{d} mod N.

One way of securing this private operation is to perform a transformation of the computation parameters used for computing s. The transformation of the parameters must be such that all or some of the parameters used for computing s are modified in full or in part every time the cryptography algorithm is executed.

The first step of the secure implementation method of the invention consists in transforming the RSA-type modulus N into an intermediate modulus N*.

N* is such that N*=x_{N}·N where x_{N} is a public value that depends both on N and on M and that makes it possible to perform any normalization of the RSA-type modulus N.

Let us take, for example, x_{N} such that x_{N}=λ²·T.

In which case λ is such that λ=ƒ(M,N) where ƒ is a function that is deterministic and public. An example of implementation of said function ƒ is presented later on in this document. It should be noted that, with the function ƒ being deterministic and public, and M and N also being public, the value λ is also public.

As regards the value T, it corresponds to the coefficient of normalization that can be used sometimes in certain types of modular multiplication algorithms, such as, for example Quisquater multiplication. When normalization of the modulus is not necessary, then the coefficient T is taken to be equal to 1.

Thus, in this example, the intermediate parameter N* is such that N*=λ²·T·N.

The second step consists in transforming M into an intermediate message M*.

M* is taken such that M*=M+x_{M}·N, where x_{M} is a random value such that x_{N} and x_{M} are coprime numbers.

Let us take, for example, x_{M} such that

x_{M}=1+λ·r₁·T.

The parameters λ and T are identical to the parameters λ and T taken for computing the intermediate modulus N*.

r₁ is an integer taken randomly using any random draw method.

Thus, the value x_{M} such that x_{M}=1+λ·r₁·T is indeed a random value that has no factor in common with the value x_{N}=λ²·T.

Once these intermediate parameters N* and M* have been computed, there remains to be computed an intermediate exponent d*.

It is possible to compute an intermediate exponent d* in random manner such that:

d*=d+r₂·(1−e·d)

In this formula, e and d are respectively the public exponent and the private exponent of the RSA cryptography algorithm and r₂ is an integer drawn randomly using any random draw method.

Once all of the intermediate parameters have been computed, it remains for the intermediate modular exponentiation s*=M*^{d}*mod N* to be computed.

The final step consists in reducing the intermediate modular exponentiation s* in order to obtain the signed value s.

For example, it is possible to perform a modular reduction so as to compute s on the basis of s* using the formula s=s*mod N.

In another implementation of the invention, the intermediate exponent d* can be such that d*=d.

In this implementation, the step consisting in computing the intermediate modular exponentiation s* differs slightly because s* is defined by the following modular exponentiation:

s*=M*^{d} mod N*.

The step consisting in reducing s* in order to obtain the signed value s remains the same.

It is important to note that the steps consisting in computing the intermediate values N*, M* and d* can be performed in a different order. The only constraint is that each of these two or three intermediate values be determined for the final computation of the modular exponentiation leading to s*.

In this computation method, the private operation consisting in generating a signature s on the basis of a message M is much more secure because of the change in the intermediate values used during the RSA-type cryptography algorithm.

The intermediate parameter M* changes every time the RSA cryptography algorithm is executed in standard mode. In addition, when the parameter d* is not taken to be equal to d, it also changes value every time the algorithm is executed.

The intermediate parameter N* changes value every time the message M to be signed varies.

Thus, successive analyses of the computation parameters do not make it possible to determine the secret indices, this being explained by the fact that the computation parameters are not constant from one execution of the algorithm to another.

In addition, this method uses a single random number r₁ only (or a second one if the intermediate parameter d* is not equal to d), which makes it possible, inter alia, to achieve savings in power (current) consumption, and also in computation time.

As explained above, the value λ is obtained from a function ƒ that is chosen to be deterministic and public. The value λ is thus obtained deterministically and publicly as a function of the message to be signed M and of the modulus N of the RSA type. The method for obtaining the value λ can, for example, be as follows.

The parameter M and the parameter N are decomposed as follows:

$$M = {\sum }_{i} {M}_{i} {2}^{w , i} and N = {\sum }_{i} {N}_{i} {2}^{w , i}$$

In this decomposition, the value of w depends on the architecture of the microprocessor with which the computations of the algorithm are performed. For example, w can be taken from among the values 8, 16, 32, or 64.

The next step consists in constructing the value:

$$λ = {\sum }_{i} {σ}_{{z}_{i}} ( {M}_{i} ) + {σ}_{{z}_{i}} ( {N}_{i} )$$

In this formula σₐ is, for example, a rotation, or more generally a function belonging to the group of the set of the permutations S of length a.

For example zᵢ is taken such that:

zⱼ=Mⱼ+j+zⱼ₋₁+Nⱼ mod 2^{w}

z₀ can be set at any value.

### RSA-Type Cryptographic Method in CRT Mode

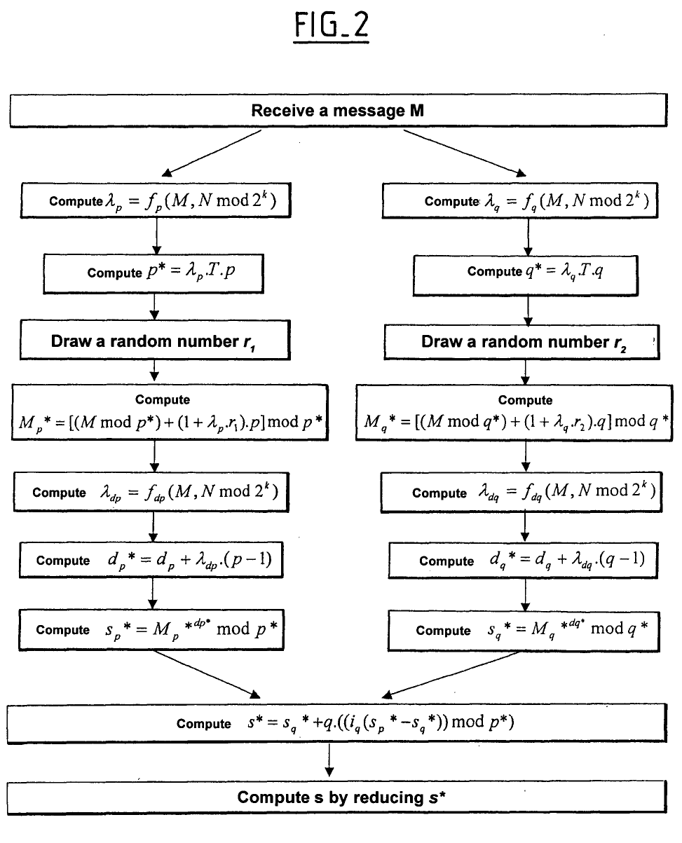

The RSA-type cryptographic method in CRT mode is described with reference to FIG. 2.

In the same way as in the standard mode, the method of securely implementing an RSA-type cryptography algorithm in CRT mode can be used both in a signature method and in a message encryption method.

Only the implementation consisting in signing a message M is described below, since the implementation consisting in decrypting a message M is identical.

Let a modulus of RSA type N be such that N=p,q, where p and q are two large prime numbers that must remain secret. Consideration is also given to a private key d in the form of a “quintuplet” (p,q,dₚ,d_{g},i_{q}), where dₚ=d mod(p−1), d_{q}=d mod(q−1), and i_{q} is the inverse of q modulo p, i.e. i_{q}=q⁻¹ mod p.

It is recalled that computing s=M^{d} mod N comes down to computing:

sₚ=M^{dp} mod p; and

s_{q}=M^{dq} mod q; then

s=s_{q}+q·((i_{q}·(sₚ−s_{q}))mod p).

It should be noted that other recombinations are possible for computing s on the basis of sₚ and s_{q}.

Once again, the private operation in CRT mode is made secure, since the computation method of the invention is based only on intermediate parameters and not on the parameters that are used conventionally.

The fact that, every time the algorithm is executed, all or some of the parameters used in the cryptography algorithm have values that have been changed prevents the secret number(s) from being determined by means of external analyses.

In addition, a limited number of random draws makes it possible to reduce the current consumption and the execution time.

In the same way as we computed the intermediate modular exponentiation s* for the standard mode, we are going, in the CRT mode, to compute the intermediate modular exponentiation sₚ* and intermediate modular exponentiation s_{q}*.

Computing the intermediate modular exponentiation sₚ* comprises the following steps.

The first step of the secure implementation method of the invention consists in transforming the modulus p into an intermediate modulus p*.

p* is such that p*=xₚ·p where xₚ is a public value that depends both on N and on M, and that makes it possible to perform any normalization of the RSA-type modulus p.

Let us take, for example, xₚ such that xₚ=λₚ·T.

In which case, λₚ is such that λₚ=ƒₚ(M,N mod 2^{k}) where ƒₚ is a function that is deterministic and public, ƒₚ being a function comparable to the function ƒ used in the standard mode, and k being a positive non-zero integer.

However, λₚ does not depend on N, but rather it depends on N mod 2^{k}. Computation of λₚ on the basis of N mod 2^{k} makes it possible not to construct the entire modulus N that is not available to us, only the values p and q being known.

It should be noted that N mod 2^{k} can be recomputed very simply by means of the following formula:

N mod 2^{k}=(p mod 2^{k})·(q mod 2^{k})mod 2^{k}

λₚ is determined on the basis of the k least significant bits of the modulus N. In a preferred implementation, k is less than 128, e.g. k=64.

By construction, λₚ is thus a value that is deterministic and public.

In the same way as in the standard mode, the coefficient T corresponds to the coefficient of normalization that is sometimes used in certain types of modular multiplication algorithms. If normalization is not necessary, then T is taken to be equal to 1.

It is then necessary to compute an intermediate parameter Mₚ* such that:

Mₚ*=[M+x_{Mp}·p] mod p*

A variant for computing Mₚ* would be to compute:

Mₚ*=[(M mod p*)+x_{Mp}·p] mod p*

Reducing M by p* makes it possible to work with elements of similar size, and thus to optimize management of the computation memory.

x_{Mp} is a random value such that xₚ and x_{Mp} are coprime numbers.

Let us take, for example, x_{Mp} such that

x_{Mp}=1+λₚ·r₁·T.

In this formula, r₁ is an integer drawn randomly using any random draw method, and λₚ is as defined above.

Once these intermediate parameters p* and Mₚ* have been computed, there remains to be computed an intermediate exponent dₚ*.

It is possible, for example, to compute an intermediate exponent dₚ* in deterministic manner such that:

dₚ*=dₚ+λ_{dp}·(p−1)

Computing this intermediate value λ_{dp} is performed in a manner analogous to the manner in which λₚ is computed, as described above. However, ƒ_{dp} is a function that is distinct from ƒₚ, so that λ_{dp} is a value distinct from λₚ.

Finally, it is necessary to compute the intermediate modular exponentiation sₚ* on the basis of the various computed intermediate values, sₚ* being such that:

sₚ*=Mₚ*^{dP*}mod p*.

In another aspect of the invention, the intermediate exponent dₚ* is taken such that dₚ*=dₚ. In order to compute sₚ*, it is thus necessary to compute:

sₚ*=Mₚ*^{dP} mod p*.

It is important to note that the steps consisting in computing the intermediate values Mₚ*, p* and dₚ* can be performed in a different order. The only constraint is that each of these two or three intermediate values be determined for the final computation of the modular exponentiation leading to sₚ*.

Computing s_{q}* takes place analogously to the computation of sₚ*.

Finally, the signed message s needs to be computed on the basis of the intermediation exponentiations sₚ* and s_{q}* that have just been computed.

The first way of computing s on the basis of sₚ* and s_{q}* is to reduce them in order to obtain respectively sₚ and s_{q}.

After having determined sₚ and s_{q}, it is necessary to recombine them by means of the Chinese remainder theorem, or of a slightly modified version, so as to obtain the signed message s, by using, for example Garner's formula:

s=s_{q}+q·((i_{q}·(sₚ−s_{q}))mod p)

Another way of computing the signed message s is to recombine the intermediate exponentiations sₚ* and s_{q}* directly.

For example, it is possible initially to compute s* using the following formula:

s*=s_{q}*+q·((i_{q}·(sₚ*−s_{q}*))mod p*)

It is then merely necessary to reduce s* in order to obtain the signed or decrypted message s. This reduction can be a modular reduction, such as, for example:

s=s*mod N

This particular recombination makes it possible, in particular, to achieve savings in memory time and in computation time.

Another computation of s directly on the basis of sₚ* and of s_{q}* consists in initially computing s* using the following formula:

s*=[x_{q}·s_{q}*+q*·((i_{q}·(sₚ*−s_{q}*))mod p*)]

It is then merely necessary to reduce s* to s. This reduction can, for example, be written:

$$s = \frac{s * mod ( {x}_{q} \cdot N )}{{x}_{q}}$$

This computation variant is preferred because it does not make it necessary to store p and q in a memory. In addition, p and q do not need to be manipulated or computed, which makes it possible to increase the security of the method of implementing the cryptography algorithm.

In addition, computation of the signed message s consisting in directly recombining the intermediate modular exponentiations sₚ* and s_{q}* as above can be used in any other cryptography method of the RSA type, in CRT mode, that uses intermediate modular exponentiations sₚ* and s_{q}* computed respectively on the basis of the intermediate moduli p* and q* (which themselves come respectively from the moduli p and q).

For example, it is possible to compute s* using the following formula:

s*=s_{q}*+q·((i_{q}·(sₚ*−s_{q}*))mod p*)

Then s* can be reduced to s by using, for example, the following modular reduction:

s=s*mod N

The use of this particular recombination makes it possible to achieve savings in memory and in computation time.

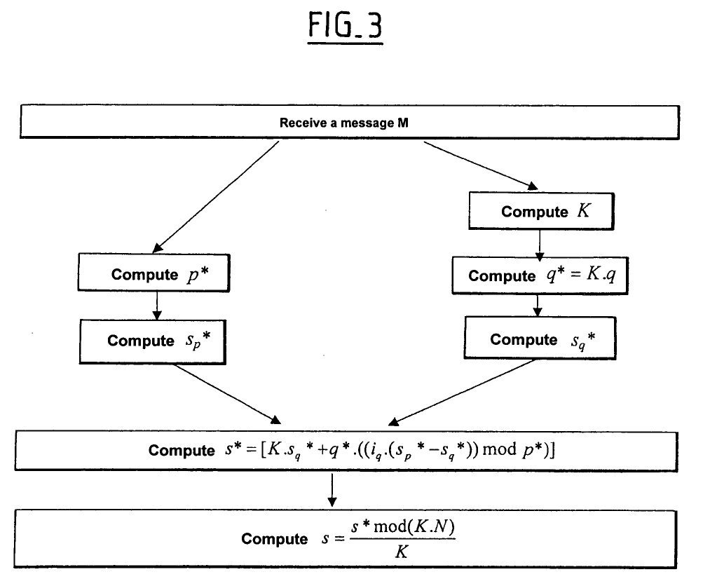

In addition, as shown in FIG. 3, if the intermediate modulus q* is computed such that q*=K·q, where K is any (deterministic or random) value, then it is possible to compute the signed or decrypted message on the basis of sₚ* and s_{q}* by initially computing s* using the following formula:

s*=[K·s_{q}*+q*·((i_{q}·(sₚ*−s_{q}*))mod p*)]

The reduction of s* makes it possible to obtain the signed or decrypted message s. For example, it is possible to use the following modular reduction:

$$s = \frac{s * mod ( K \cdot N )}{K}$$

In which case, the savings in memory and in computation time are increased because p and q are not manipulated, which reinforces security.

The reader will understand that numerous modifications can be made without going beyond the novel teachings and advantages described herein. Therefore, any such modifications lie within the scope of the cryptographic method of the invention and of the electronic components making it possible to implement said method.

1. An asymmetric cryptographic method applied to a message M, said method comprising a private operation of signing or decrypting the message M for the purpose of obtaining a signed or decrypted message s, the private operation being defined on the basis of at least one modular exponentiation EM of the form EM=M^{A} mod B, where A and B are respectively the exponent and the modulus of the modular exponentiation EM, wherein the private operation includes the following steps:
computing an intermediate modulus B*, an intermediate message M*, and an intermediate exponent A*, as a function of B, M, and/or A; the intermediate modulus B* being computed deterministically and the intermediate message M* being computed randomly;
computing an intermediate modular exponentiation EM*=M*^{A}*mod B*; and
signing or decrypting the message s on the basis of the intermediate modular exponentiation EM*.

2. A method according to claim 1, wherein the step of signing or decrypting the message s is performed by reducing the intermediate modular exponentiation EM*.

3. A method according to claim 2, wherein a public key and a private key are used, the public key being composed of a modulus N of the RSA type and of a public exponent e, and the private key being composed of the modulus N of the RSA type and of a private exponent d, such that e·d=1 mod φ(N), where φ is Euler's totient function, and wherein the private operation is defined on the basis of the modular exponentiation s=M^{d} mod N, where d and N correspond respectively to the exponent A and to the modulus B of the modular exponentiation EM, and comprises the following steps consisting in:
a) computing an intermediate modulus N* in a deterministic manner, such that N*=x_{N}·N, where x_{N} is a public value that depends on N and on M;
b) computing an intermediate message M* in a random manner, such that M*=M+x_{M}·N, where x_{M} is a random value such that x_{N} and x_{M} are coprime;
c) computing an intermediate modular exponentiation s*=M*^{d}*mod N*, where d* corresponds to the intermediate exponent A*; and
d) reducing the intermediate modular exponentiation s* in order to obtain the signed or decrypted message s.

4. A method according to claim 3, wherein step a) of computing an intermediate modulus N* in a deterministic manner comprises the following steps:
a1) computing a value λ such that λ=ƒ(M,N), where ƒ is a function that is deterministic and public;
a2) computing the public value x_{N} such that x_{N}=λ²·T, where T is a coefficient of normalization of the modular multiplication; and
a3) computing the intermediate modulus N* such that N*=x_{N}·N.

5. A method according to claim 4, wherein step b) of computing an intermediate message M* in a random manner comprises the following steps:
b1) drawing a random number r₁;
b2) computing x_{M}=1+λ·r₁·T; and
b3) computing the intermediate message
M*=M+x_{M}·N.

6. A method according to claim 4 wherein step a1) of computing the value λ comprises the following steps:
a11) decomposing M and N such that
$$M = {\sum }_{i} {M}_{i} {2}^{w . i} and N = {\sum }_{i} {N}_{i} {2}^{w . i}$$
where w is a non-zero integer; and
a12) constructing the value λ such that
$$λ = {\sum }_{i} {σ}_{{z}_{i}} ( {M}_{i} ) + {σ}_{{z}_{i}} ( {N}_{i} )$$
where σₐ is a function belonging to the set of the permutations S of length a, and where zⱼ=Mⱼ+j+zⱼ₋₁+Nⱼ mod 2^{w}, where z₀ can be any value.

7. A method according to claim 3, wherein the intermediate exponent d* is such that d*=d+r₂·(1−e·d), where r₂ is a number drawn randomly.

8. A method according to claim 3, wherein the intermediate exponent d* is such that d*=d.

9. A method according to claim 1, wherein a public key and a private key are used, the public key being composed of a public exponent e and of a modulus N of the RSA type that is the product of two large prime numbers p and q, and the private key being composed of the “quintuplet” (p,q,dₚ,d_{q},i_{q}), where dₚ=d mod(p−1), d_{q}=d mod(q−1), and i_{q}=q⁻¹ mod p, where d is such that e·d=1 mod φ(N), where φ is Euler's totient function, and wherein the private operation is defined on the basis of the modular exponentiation sₚ=M^{dp} mod p, where dₚ, and p correspond respectively to the exponent A and to the modulus B of the modular exponentiation EM, and comprises the following steps:
a1) computing an intermediate modulus p* in a deterministic manner, such that p*=xₚ·p, where xₚ is a public value that depends on N and on M;
a2) computing an intermediate message Mₚ* in a random manner, such that Mₚ*=[(M mod p*)+x_{Mp}·p] mod p*, where x_{Mp} is a random value such that xₚ and x_{Mp} are coprime; and
a3) computing an intermediate modular exponentiation sₚ* such that sₚ*=Mₚ*^{dp*}mod p*, where dₚ* corresponds to the intermediate exponent A*.

10. A method according to claim 9, wherein step a2) is replaced with step a2′) comprising computing an intermediate message Mₚ* such that Mₚ*=[M+x_{Mp}·p] mod p*, where x_{Mp} is a random value such that xₚ and x_{Mp} are coprime.

11. A method according to claim 9 wherein step a1) of computing an intermediate modulus p* in a deterministic manner comprises the following steps:
a11) computing a value λₚ such that λₚ=ƒₚ(M,N mod 2^{k}), where ƒₚ is a function that is deterministic and public, and k is a positive non-zero integer;
a12) computing the public value xₚ such that xₚ=λₚ·T, where T is a coefficient of normalization of the modular multiplication; and
a13) computing the intermediate modulus p*.

12. A method according to claim 11, wherein step a2) of computing an intermediate message Mp* in a random manner comprises the following steps:
a21) drawing a random number r₁;
a22) computing the random value x_{Mp} such that
x_{Mp}=1+λₚ·r₁·T; and
a23) computing the intermediate message Mₚ*.

13. A method according to claim 9, wherein the intermediate exponent dₚ* is such that dₚ*=dₚ+λ_{dp}·(p−1), where λ_{dp} is such that λ_{dp}=f_{dp}(M,N mod 2^{k}), where f_{dp} is a function that is deterministic and public, and k is a positive non-zero integer.

14. A method according to claim 9, wherein the intermediate exponent dₚ* is such that dₚ*=dₚ.

15. A method according to claim 9, wherein the private operation is further defined on the basis of the modular exponentiation s_{q}=M^{dq} mod q, and comprises the following steps:
b1) computing an intermediate modulus q* in a deterministic manner, such that q*=x_{q}·q, where x_{q} is a public value that depends on N and on M;
b2) computing an intermediate message M_{q}* in a random manner, such that M_{q}*=[(M mod q*)+x_{Mq}·q] mod p*, where x_{Mq} is a random value such that x_{q} and x_{Mq} are coprime; and
b3) computing an intermediate modular exponentiation s_{q}* such that s_{q}*=M_{q}*^{dq*}mod q*, where d_{q}* is an intermediate exponent.

16. A method according to claim 15, wherein step b2) is replaced with step b2′) comprising computing an intermediate message M_{q}* such that M_{q}*=[M+x_{Mq}·q] mod q*, where x_{Mq} is a random value such that x_{q} and x_{Mq} are coprime.

17. A method according to claim 15 wherein step b1) of computing an intermediate modulus q* in deterministic manner comprises the following steps:
b11) computing a value λ_{q} such that λ_{q}=ƒ_{q}(M,N mod 2^{k}), where ƒ_{q} is a function that is deterministic and public, and k is a positive non-zero integer;
b12) computing the public value x_{q} such that x_{q}=λ_{q}·T, where T is a coefficient of normalization of the modular multiplication; and
b13) computing the intermediate modulus q*.

18. A method according to claim 17, wherein step b2) of computing an intermediate message Mq* in a random manner comprises the following steps:
b21) drawing a random number r₂;
b22) computing the random value x_{Mq} such that
x_{Mq}=1+λ_{q}·r₂·T; and
b23) computing the intermediate message M_{q}*.

19. A method according to claim 15, wherein the intermediate exponent d_{q}* is such that d_{q}*=d_{q}+λ_{dq}(q−1), where λ_{dq} is such that λ_{dq}=f_{dq}(M,N mod 2^{k}), where f_{dq} is a function that is deterministic and public, and k is a positive non-zero integer.

20. A method according to claim 15, wherein the intermediate exponent d_{q}* is such that d_{q}*=d_{q}.

21. A method according to claim 11, wherein the number k is less than 128.

22. A method according to claim 9, wherein the private operation further comprises the step of computing the modular exponentiation s=M^{d} mod N on the basis of sₚ* and s_{q}*.

23. A method according to claim 22, wherein the step of computing the modular exponentiation s=M^{d} mod N on the basis of sₚ* and s_{q}* comprises the following steps:
recombining sₚ* and s_{q}* such that:
s*=s_{q}*+q·((i_{q}·(sₚ*−s_{q}*))mod p*); and
reducing s* to s.

24. A method according to claim 23, wherein the step of reducing s* to s is performed using the modular reduction s=s*mod N.

25. A method according to claim 22, wherein the step of computing the modular exponentiation s=M^{d} mod N on the basis of sₚ* and s_{q}* comprises the following steps:
recombining sₚ* and s_{q}* such that:
s*=[x_{q}·s_{q}*+q*·((i_{q}·(sₚ*−s_{q}*))mod p*)]; and
computing:
$$s = \frac{s * mod ( {x}_{q} \cdot N )}{{x}_{q}}$$

26. A method according to claim 22, wherein the step of computing the modular exponentiation s=M^{d} mod N on the basis of sₚ* and s_{q}* comprises the following steps:
reducing the modular exponentiation sₚ* in order to determine the modular exponentiation sₚ;
reducing the modular exponentiation s_{q}* in order to determine the modular exponentiation s_{q}; and
recombining sₚ and s_{q} such that:
s=s_{q}+q·((i_{q}·(sₚ−s_{q}))mod p).

27. An asymmetric cryptographic method applied to a message M to be signed or decrypted into a signed or decrypted message s, said cryptographic method being using a public key and a private key, the public key being composed of a public exponent e and of a modulus N of the RSA type that is the product of two large prime numbers p and q, and the private key being composed of the “quintuplet” (p,q,dₚ,d_{q},i_{q}), where dₚ=d mod(p−1), d_{q}=d mod(q−1), and i_{q}=q⁻¹ mod p, where d is such that e·d=1 mod φ(N), where φ is Euler's totient function, and including a private operation defined on the basis of the modular exponentiations sₚ and s_{q} such that sₚ=M^{dp} mod p, and s_{q}=M^{dq} mod q, the private operation comprising the following steps:
computing an intermediate modulus p* on the basis of p, and an intermediate modus q* on the basis of q;
computing the intermediate modular exponentiations sₚ* and s_{q}*, sₚ* and s_{q}* being computed respectively on the basis of the moduli p* and q*; and
signing or decrypting the message s by combining sₚ* and s_{q}*.

28. A method according to claim 27, wherein the message s is signed or decrypted using the following steps:
recombining sₚ* and s_{q}* such that:
s*=s_{q}*+q·((i_{q}·(sₚ*−s_{q}*))mod p*); and
reducing s* to s.

29. A method according to claim 28, wherein the step of reducing s* to s is performed using the modular reduction s=s*mod N.

30. A method according to claim 27, wherein the intermediate modulus q* is computed such that q*=K·q, where K is a deterministic or random value, and wherein the message s is signed or decrypted using the following steps:
recombining sₚ* and s_{q}* such that:
s*=[K·s_{q}*+q*·((i_{q}·(sₚ*−s_{q}*))mod p*)]
computing:
$$s = \frac{s * mod ( K \cdot N )}{K}$$

31. An electronic component, that includes means for implementing the cryptographic method according to claim 1.

32. A smart card including an electronic component according to claim 31.
